(19) United States
(12) Patent Application Publication
(10) Pub. No.: US 2026/0280074 A1
(43) Pub. Date: Sep. 17, 2026

(54) HORN, TERMINAL COMPONENT, AND SECONDARY BATTERY

(71) Applicants: Prime Planet Energy & Solutions, Inc., Tokyo (JP); Fukui Byora Co., Ltd., Awara-city (JP)

(72) Inventors: Takahiro SAKURAI, Nagoya-shi (JP); Kosuke SUZUKI, Toyota-shi (JP); Kota OHATA, Toyota-shi (JP); Takeshi SHIMASAKI, Awara-shi (JP)

(21) Appl. No.: 19/681,091

(22) Filed: May 19, 2026

Related U.S. Application Data
(62) Division of application No. 17/865,389, filed on Jul. 15, 2022.

(30) Foreign Application Priority Data
Jul. 19, 2021 (JP) 2021-119017

(51) Int. Cl. H01M 50/566; B06B 1/02; H01M 50/103

(52) U.S. Cl. CPC H01M 50/566; B06B 1/02; H01M 50/103; H01M 2220/20

(57) ABSTRACT

A horn disclosed herein is a horn that transmits ultrasonic vibration to workpiece to be joined and includes a base portion and a tip end portion that protrudes from the base portion and is pressed against the workpiece. At least a portion of the tip end portion is a frame-like raised portion formed into substantially a frame shape. The frame-like raised portion may be formed into a rectangular shape. As a portion of the tip end portion, an inner raised portion may be provided inside the frame-like raised portion.

### CROSS REFERENCE TO RELATED APPLICATIONS

The present application is a divisional of U.S. application Ser. No. 17/865,389, filed Jul. 15, 2022, which claims the priority based on Japanese Patent Application No. 2021-119017 filed on Jul. 19, 2021, the entire contents of which are incorporated in the present specification by reference.

### BACKGROUND

The present disclosure relates to a horn, a terminal component, and a secondary battery.

In order to produce a terminal component formed of a plurality of metals, it has been proposed to join the metals together by ultrasonic joining. A horn that transmits ultrasonic vibration to workpieces to be joined is used for ultrasonic joining.

Japanese Laid-open Patent Publication No. 2007-330851 discloses a horn used for ultrasonic joining. The horn disclosed in Japanese Laid-open Patent Publication No. 2007-330851 has a plurality of protrusions on a surface that pressurizes workpieces to be joined and ultrasonically vibrates the workpieces to be joined while pressing the workpieces via the plurality of protrusions. The protrusions are hexagonal pyramidal protrusions and are configured such that an opposing direction of a pair of surfaces of each of the protrusions that are opposed to each other is perpendicular to a vibration direction. In accordance with the horn, occurrence and scattering of burrs can be suppressed and a change in shape due to wear of the protrusions can be made small.

Japanese Laid-open Patent Publication No. 2018-156841 discloses an electrode joining structure in which electrodes are joined together by ultrasonic joining. Japanese Laid-open Patent Publication No. 2018-156841 also discloses a horn used for producing the electrode joining structure. The horn includes a plurality of protrusions on a pressurizing surface of a horn base portion and the plurality of protrusions are arranged in a circular arc shape. A plurality of areas in which protrusions are arranged in a circular arc shape are provided. A trench is formed between the protrusions and between the areas in which the plurality of protrusions are arranged. By using the above-described horn, occurrence of cuts, breaks, and burrs of a joining structure can be suppressed.

### SUMMARY

Incidentally, depending on a purpose of use of a secondary battery, a large load is applied to a joining portion joined by ultrasonic joining in some cases. For example, in a case where a secondary battery is used as an on-vehicle secondary battery, traveling vibration of a vehicle is transmitted to an external terminal of the secondary battery through a bus bar. Therefore, a large load can be also applied to a joining portion of the bus bar and the external terminal. In order to maintain a joining state achieved by ultrasonic joining for a long period, it is required to increase joining strength of the joining portion.

In view of the forgoing, the present disclosure has been devised, and it is therefore an object of the present disclosure to provide a terminal component having high joining strength and to provide a horn used for producing the terminal component.

A horn disclosed herein transmits ultrasonic vibration to a workpiece to be joined and includes a base portion and a tip end portion that protrudes from the base portion and is pressed against the workpiece. At least a portion of the tip end portion is a frame-like raised portion formed into a frame shape. By performing ultrasonic joining using the horn having the above-described structure, joining strength of ultrasonic joining can be increased.

The frame-like raised portion may be formed into a rectangular shape. As a portion of the tip end portion, an inner raised portion may be provided inside the frame-like raised portion. According to the above-described structure, joining strength of the workpieces to be joined can be further increased.

The terminal component disclosed herein includes a first metal and a second metal. A joining portion joined by ultrasonic joining is formed at a boundary of the first metal and the second metal. The joining portion includes a frame-like joining area formed into a frame shape. In the terminal component having the above-described structure, joining strength of the first metal and the second metal is increased.

The frame-like joining area may have a rectangular shape. The joining portion may include an inner joining area inside the frame-like joining area. According to the above-described structure, the joining strength of the first metal and the second metal can be further increased.

As another aspect of a technology disclosed herein, a secondary battery including an electrode body including a positive electrode and a negative electrode, a battery case housing the electrode body therein, and a positive electrode terminal and a negative electrode terminal electrically connected to the positive electrode and the negative electrode of the electrode body, respectively, is provided. At least one of the positive electrode terminal and the negative electrode terminal may include the terminal component disclosed herein.

### BRIEF DESCRIPTION OF THE DRAWINGS

FIG. 1 is a partial cross-sectional view of a lithium-ion secondary battery 10.

FIG. 2 is a cross-sectional view illustrating a cross section taken along the line II-II of FIG. 1.

FIG. 3 is a cross-sectional view illustrating a cross section taken along the line III-III of FIG. 2.

FIG. 4 is a cross-sectional view schematically illustrating a terminal component 200.

FIG. 5 is a schematic view of a horn 100 when viewed from top.

FIG. 6 is a cross-sectional view illustrating a cross section taken along the line VI-VI of FIG. 5.

FIG. 7 is a schematic view illustrating a shape of a joining portion 203.

FIG. 8 is a schematic view illustrating a horn 120 that was used for producing a first comparative example.

### DETAILED DESCRIPTION

One embodiment of a horn, a terminal component, and a secondary battery disclosed herein will be described below. As a matter of course, the embodiment described herein is not intended to be particularly limiting the present disclosure. The accompanying drawings are schematic and do not necessarily reflect actual members or portions. The notation “A to B” or the like that indicates a numerical range means “A or more and B or less” unless specifically stated otherwise. Note that, in the following drawings, members/portions that have the same effect may be denoted by the same sign and the overlapping description may be omitted or simplified.

As used herein, a term “secondary battery” refers to overall storage devices in which charge carriers move between a pair of electrodes (a positive electrode and a negative electrode) via an electrolyte and thus a charging and discharging reaction occurs. Such secondary batteries include not only so-called storage batteries, such as a lithium-ion secondary battery, a nickel hydrogen battery, a nickel cadmium battery, or the like, but also capacitors, such as an electric double-layered capacitor or the like. Among the above-described secondary batteries, an embodiment in which a lithium-ion secondary battery is a target will be described below.

### Lithium-Ion Secondary Battery 10

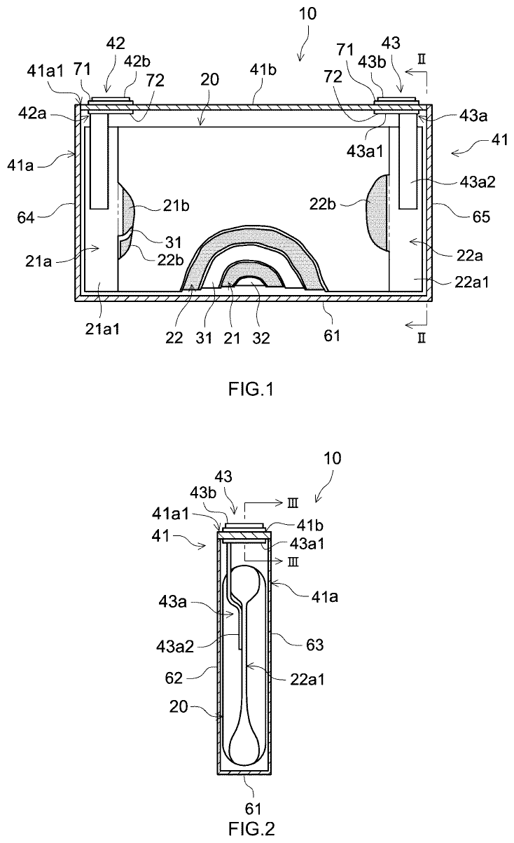

FIG. 1 is a partial cross-sectional view of a lithium-ion secondary battery 10. In FIG. 1, a state where an inside of the lithium-ion secondary battery 10 is exposed along a broad width surface on one side of a battery case 41 having an approximately rectangular parallelepiped shape is illustrated. The lithium-ion secondary battery 10 illustrated in FIG. 1 is a so-called sealed battery. FIG. 2 is a cross-sectional view illustrating a cross section taken along the line II-II of FIG. 1. In FIG. 2, a partial cross-sectional view in a state where the inside of the lithium-ion secondary battery 10 is exposed along a narrow width surface on one side of the battery case 41 having an approximately rectangular parallelepiped shape is schematically illustrated.

As illustrated in FIG. 1, the lithium-ion secondary battery 10 includes an electrode body 20, the battery case 41, a positive electrode terminal 42, and a negative electrode terminal 43.

### Electrode Body 20

The electrode body 20 is housed in the battery case 41 in a state where the electrode body 20 is covered by an insulation film (not illustrated) or the like. The electrode body 20 includes a positive electrode sheet 21 as a positive element, a negative electrode sheet 22 as a negative electrode element, and separator sheets 31 and 32 as separators. Each of the positive electrode sheet 21, the first separator sheet 31, the negative electrode sheet 22, and the second separator sheet 32 is a long band-like member.

The positive electrode sheet 21 is configured such that a positive electrode active material layer 21b containing a positive electrode active material is formed on each of both surfaces on a positive electrode current collecting foil 21a (for example, an aluminum foil) having preset width and thickness excluding an unformed portion 21a1 set to have a uniform width in an end portion on one side in a width direction. For example, in a lithium-ion secondary battery, the positive electrode active material is a material, such as a lithium transition metal compound material, that releases lithium ions during charging and absorbs lithium ions during discharging. In general, various other materials than the lithium transition metal compound material have been proposed for positive electrode active materials, and there is no particular limitation on the positive electrode active material used herein.

The negative electrode sheet 22 is configured such that a negative electrode active material layer 22b containing a negative electrode active material is formed on each of both surfaces on a negative electrode current collecting foil 22a (a copper foil herein) having preset width and thickness excluding an unformed portion 22a1 set to have a uniform width in an end portion on one side in the width direction. For example, in a lithium-ion secondary battery, the negative electrode active material is a material, such as natural graphite, that absorbs lithium ions during charging and releases absorbed lithium ions during discharging. In general, various other materials than the natural graphite have been proposed for negative electrode active materials, and there is no particular limitation on the negative electrode active material used herein.

For each of the separator sheets 31 and 32, for example, a porous resin sheet through which an electrolyte with a required heat resistance can pass is used. Various proposals have been made for the separator sheets 31 and 32, and there is no particular limitation on the separator sheets 31 and 32.

Herein, the negative electrode active material layer 22b is formed, for example, to have a width larger than that of the positive electrode active material layer 21b. Each of the separator sheets 31 and 32 has a width larger than that of the negative electrode active material layer 22b. The unformed portion 21a1 of the positive electrode current collecting foil 21a and the unformed portion 22a1 of the negative electrode current collecting foil 22a are disposed to face opposite directions away from each other in the width direction. The positive electrode sheet 21, the first separator sheet 31, the negative electrode sheet 22, and the second separator sheet 32 are stacked in this order and are wound such that directions thereof are aligned to a long-side direction. The negative electrode active material layer 22b covers the positive electrode active material layer 21b with the separator sheets 31 and 32 interposed between the negative electrode active material layer 22b and the positive electrode active material layer 21b. The negative electrode active material layer 22b is covered by the separator sheets 31 and 32. The unformed portion 21a1 of the positive electrode current collecting foil 21a protrudes from one side of the separator sheets 31 and 32 in the width direction. The unformed portion 21a1 of the negative electrode current collecting foil 22a protrudes from the separator sheets 31 and 32 at an opposite side in the width direction.

As illustrate in FIG. 1, the above-described electrode body 20 is formed to be flat along a single plane including a winding axis to be housed in a case body 41a of the battery case 41. The unformed portion 21a1 of the positive electrode current collecting foil 21a is disposed on one side along the winding axis of the electrode body 20 and the unformed portion 22a1 of the negative electrode current collecting foil 22a is disposed on an opposite side.

### Battery Case 41

As illustrated in FIG. 1, the battery case 41 houses the electrode body 20 therein. The battery case 41 includes the case body 41a having an approximately rectangular parallelepiped shape with an opening on one side surface and a lid 41b attached to the opening. In this embodiment, from a view point of reducing a weight and ensuring a required rigidity, each of the case body 41a and the lid 41b is formed of aluminum or an aluminum alloy mainly containing aluminum.

### Case Body 41a

The case body 41a has an approximately rectangular parallelepiped shape with an opening on one side surface. The case body 41a has an approximately rectangular bottom surface portion 61, a pair of broad width surface portions 62 and 63 (see FIG. 2), and a pair of narrow width surface portions 64 and 65. Each of the pair of broad width surface portions 62 and 63 rises from a corresponding longer side of the bottom surface portion 61. Each of the pair of narrow width surface portions 64 and 65 rises from a corresponding shorter side of the bottom surface portion 61. An opening 41a1 surrounded by the pair of broad width surface portions 62 and 63 and the pair of narrow width surface portions 64 and 65 is formed in one side surface of the case body 41a.

### Lid 41b

The lid 41b is attached to the opening 41a1 of the case body 41a surrounded by longer sides of the pair of broad width surface portions 62 and 63 (see FIG. 2) and shorter sides of the pair of narrow width surface portions 64 and 65. A peripheral portion of the lid 41b is joined to an edge of the opening 41a1 of the case body 41a. The above-described joining may be achieved, for example, by continuous welding without any gap. Such welding can be realized, for example, by laser welding.

In this embodiment, the positive electrode terminal 42 and the negative electrode terminal 43 are mounted on the lid 41b. The positive electrode terminal 42 includes an internal terminal 42a and an external terminal 42b. The negative electrode terminal 43 includes an internal terminal 43a and an external terminal 43b. Each of the internal terminals 42a and 43a is mounted on an inside of the lid 41b via an insulator 72. Each of the external terminals 42b and 43b is mounted on an outside of the lid 41b via a gasket 71. Each of the internal terminals 42a and 43a extends inside the battery case 41. The internal terminal 42a of the positive electrode is connected to the unformed portion 21a1 of the positive electrode current collecting foil 21a. The internal terminal 43a of the negative electrode is connected to the unformed portion 22a1 of the negative electrode current collecting foil 22a.

The unformed portion 21a1 of the positive electrode current collecting foil 21a and the unformed portion 22a1 of the negative electrode current collecting foil 22a in the electrode body 20 are mounted on the internal terminals 42a and 43a each being mounted on a corresponding one of both side portions of the lid 41b in a longitudinal direction, respectively, as illustrated in FIG. 1. The electrode body 20 is housed in the battery case 41 so as to be mounted on the internal terminals 42a and 43a each being mounted on the lid 41b. Note that, herein, a wound type electrode body 20 is illustrated as an example. A structure of the electrode body 20 is not limited to the above-described structure. The structure of the electrode body 20 may be, for example, a stacked structure in which a positive electrode sheet and a negative electrode sheet are alternately stacked via a separator sheet therebetween. A plurality of electrode bodies 20 may be housed in the battery case 41.

The battery case 41 may be configured to house an unillustrated electrolytic solution with the electrode body 20. As the electrolytic solution, a nonaqueous electrolytic solution obtained by dissolving a supporting salt into a non-aqueous solvent may be used. Examples of the non-aqueous solvent include a carbonate base solvent, such as ethylene carbonate, dimethyl carbonate, ethyl methyl carbonate, or the like. Examples of the supporting salt include a fluorine-containing lithium salt, such as LiPF₆ or the like.

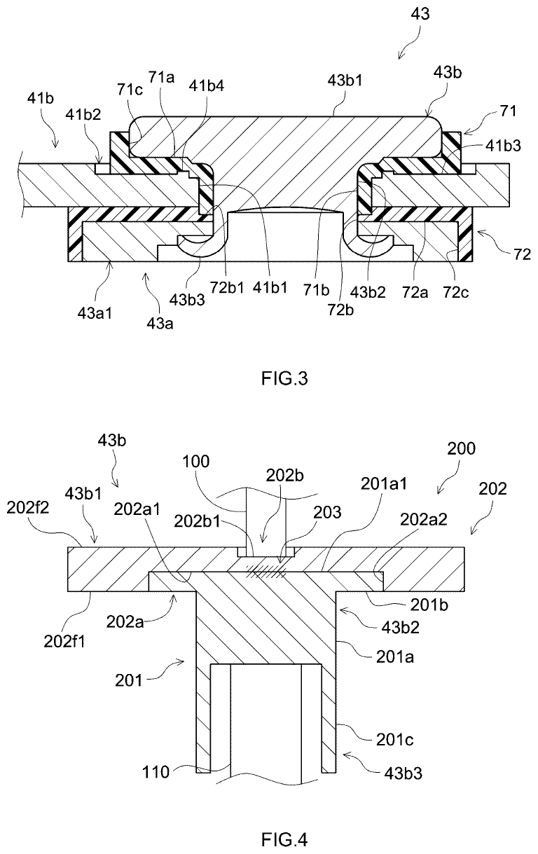

FIG. 3 is a cross-sectional view illustrating a cross section taken along the line III-III of FIG. 2. In FIG. 3, a cross section of a portion in which the negative electrode terminal 43 is mounted on the lid 41b is illustrated. In this embodiment, a member obtained by joining dissimilar metals is used for the external terminal 43b of the negative electrode. In FIG. 3, a structure of the dissimilar metals forming the external terminal 43b, an interface of the dissimilar metals, and the like are not illustrated and a cross-sectional shape of the external terminal 43b is schematically illustrated.

As illustrated in FIG. 3, the lid 41b includes a mounting hole 41b1 used for mounting the external terminal 43b of the negative electrode. The mounting hole 41b1 passes through the lid 41b in a preset position of the lid 41b. The internal terminal 43a and the external terminal 43b of the negative electrode are mounted in the mounting hole 41b1 of the lid 41b with the gasket 71 and the insulator 72 interposed therebetween. At an outside of the mounting hole 41b1, a step 41b2 to which the gasket 71 is attached is provided around the mounting hole 41b1. A seating surface 41b3 on which the gasket 71 is disposed is provided on the step 41b2. A protrusion 41b4 used for positioning the gasket 71 is provided on the seating surface 41b3.

As illustrated in FIG. 3, the external terminal 43b of the negative electrode includes a head portion 43b1, a shaft portion 43b2, and a caulking piece 43b3. The head portion 43b1 is a portion disposed on the outside of the lid 41b. The head portion 43b1 is an approximately flat plate-like portion larger than the mounting hole 41b1. The shaft portion 43b2 is a portion mounted in the mounting hole 41b1 via the gasket 71. The shaft portion 43b2 protrudes downward from an approximately center portion of the head portion 43b1. As illustrated in FIG. 3, the caulking piece 43b3 is a portion caulked to the internal terminal 43a of the negative electrode inside the lid 41b. The caulking piece 43b3 extends from the shaft portion 43b2, is bent after being inserted in the lid 41b, and is caulked to the internal terminal 43a of the negative electrode.

### Gasket 71

As illustrated in FIG. 3, the gasket 71 is a member mounted on the mounting hole 41b1 and the seating surface 41b3 of the lid 41b. In this embodiment, the gasket 71 includes a seating portion 71a, a boss portion 71b, and a side wall 71c. The seating portion 71a is a portion attached to the seating surface 41b3 provided on an outer surface of the lid 41b around the mounting hole 41b1. The seating portion 71a includes an approximately flat surface in accordance with the seating surface 41b3. The seating portion 71a includes a recess corresponding to the protrusion 41b4 of the seating surface 41b3. The boss portion 71b protrudes from a bottom surface of the seating portion 71a. The boss portion 71b has an outer shape along an inner surface of the mounting hole 41b1 to be mounted in the mounting hole 41b1. An inner surface of the boss portion 71b is an attaching hole to which the shaft portion 43b2 of the external terminal 43b is attached. The side wall 71c rises upward from a peripheral edge of the seating portion 71a and extends upward. The head portion 43b1 of the external terminal 43b is attached to a portion of the gasket 71 surrounded by the side wall 71c.

The gasket 71 is disposed between the lid 41b and the external terminal 43b to ensure insulation between the lid 41b and the external terminal 43b. The gasket 71 ensures airtightness of the mounting hole 41b1 of the lid 41b. In view of the foregoing, a material excellent in chemical resistance and weather resistance may be used. In this embodiment, PFA is used for the gasket 71. PFA is a tetrafluoroethylene-perfluoroalkylvinylether copolymer. Note that a material used for the gasket 71 is not limited to PFA.

### Insulator 72

The insulator 72 is a member attached to the inside of the lid 41b around the mounting hole 41b1 of the lid 41b. The insulator 72 includes a bottom wall 72a, a hole 72b, and a side wall 72c. The bottom wall 72a is a portion disposed along the inner surface of the lid 41b. In this embodiment, the bottom wall 72a is an approximately flat plate-like portion. The bottom wall 72a is disposed along the inner surface of the lid 41b and has a size with which the bottom wall 72a does not protrude from the lid 41b so as to be accommodated in the case body 41a. The hole 72b is a hole provided to correspond to the inner surface of the boss portion 71b of the gasket 71. In this embodiment, the hole 72b is provided in an approximately center portion of the bottom wall 72a. A step 72b1 that is recessed is provided around the hole 72b on a side surface opposed to the inner surface of the lid 41b. A tip end of the boss portion 71b of the gasket 71 attached to the mounting hole 41b1 is accommodated in the step 72b1 without interference. The side wall 72c rises from a peripheral edge portion of the bottom wall 72a and extends downward. A base portion 43a1 provided at one end of the internal terminal 43a of the negative electrode is accommodated in the bottom wall 72a. The insulator 72 is provided inside the battery case 41, and therefore, may have a required chemical resistance. In this embodiment, PPS is used for the insulator 72. PPS is poly phenylene sulfide resin. Note that a material used for the insulator 72 is not limited to PPS.

The internal terminal 43a of the negative electrode includes the base portion 43a1 and a connection piece 43a2 (see FIG. 1 and FIG. 2). The base portion 43a1 is a portion attached to the bottom wall 72a of the insulator 72. In this embodiment, the base portion 43a1 has a shape corresponding to an inside of the side wall 72c around the bottom wall 72a of the insulator 72. The connection piece 43a2 extends from one end of the base portion 43a1, further extends in the case body 41a, and is connected to the unformed portion 22a1 of the negative electrode of the electrode body 20 (see FIG. 1 and FIG. 2).

In this embodiment, the boss portion 71b is attached to the mounting hole 41b1 and the gasket 71 is mounted on the outside of the lid 41b. The external terminal 43b is attached to the gasket 71. At this time, the shaft portion 43b2 of the external terminal 43b is inserted through the boss portion 71b of the gasket 71 and the head portion 43b1 of the external terminal 43b is disposed on the seating portion 71a of the gasket 71. The insulator 72 and the negative electrode terminal 43 are mounted on the inside of the lid 41b. As illustrated in FIG. 3, the caulking piece 43b3 of the external terminal 43b is bent and is caulked to the base portion 43a1 of the negative electrode terminal 43. The caulking piece 43b3 of the external terminal 43b and the base portion 43a1 of the negative electrode terminal 43 may be partially joined together by welding or metal joining in order to improve conductivity.

Incidentally, in the internal terminal 42a (see FIG. 1) of the positive electrode of the lithium-ion secondary battery 10, a required level of oxidation reduction resistance is not as high as that in the positive electrode. In view of the required oxidation reduction resistance and reduction in weight, aluminum can be used for the internal terminal 42a of the positive electrode. In contrast, in the internal terminal 43a of the negative electrode, a required level of oxidation reduction resistance is higher than that in the positive electrode. In view of the foregoing, copper can be used for the internal terminal 43a of the negative electrode. On the other hand, in the bus bar to which the external terminal 43b is connected, in view of reduction in weight and cost cut, aluminum or an aluminum alloy can be used.

The present inventor has examined use of different types of metals in a portion connected to the internal terminal 43a and a portion connected to the bus bar. That is, the present inventor has examined use of a metal having high weldability for the portion connected to the bus bar and the portion connected to the internal terminal 43a in the external terminal 43b. However, in findings of the present inventor, there are problems regarding conductivity and joining strength in dissimilar metal joining. In order to ensure conduction between metals, the present inventor has examined metallurgically joining and increasing the joining strength of the joining portion. A terminal component 200 disclosed herein will be described below.

### Terminal Component 200

FIG. 4 is a cross-sectional view schematically illustrating the terminal component 200. The terminal component 200 can be used as the external terminal 43b of the negative electrode illustrated in FIG. 3. In FIG. 4, for the terminal component 200, a structure of dissimilar metals and an interface of the dissimilar metals are schematically illustrated. In FIG. 4, steps of joining a first metal 201 and a second metal 202 forming the terminal component 200 to each other by ultrasonic joining are schematically illustrated.

As illustrated in FIG. 4, the terminal component 200 includes the first metal 201 and the second metal 202 stacked on the first metal 201. In this embodiment, the first metal 201 is formed of copper. The second metal is formed of aluminum. A joining portion 203 joined by ultrasonic joining is formed at a boundary between the first metal 201 and the second metal 202. For the terminal component 200, a method for producing the terminal component 200 and a horn 100 used for producing the terminal component will be described below.

The first metal 201 is disposed to face the inside of the battery case 41 (see FIG. 1 and FIG. 2) of the terminal component 200 and forms a portion connected to the internal terminal 43a (see FIG. 3) of the negative electrode. The first metal 201 can be prepared, for example, by processing a material (copper in this embodiment) of the first metal 201 into a predetermined shape. Examples of a processing method include, for example, a known metal processing method, such as forge processing, cutting, or the like.

In this embodiment, the first metal 201 includes a shaft portion 201a and a flange portion 201b extending from one end of the shaft portion 201a in an outer diameter direction. An end portion 201a1 of the first metal 201 in which the flange portion 201b is provided has a circular shape. The flange portion 201b is continuously formed in a circumferential direction of the shaft portion 201a. The outer edge of the flange portion 201b is formed so as to be perpendicular to the end portion 201a1. In the shaft portion 201a, a portion 201c serving as the caulking piece 43b3 further caulked to the internal terminal 43a is provided on an opposite side to a side on which the flange portion 201b is provided.

The second metal 202 forms a portion of the terminal component 200 exposed to the outside of the battery case 41 (see FIG. 1) and connected to an external connection potion, such as a bus bar or the like. Similar to the first metal 201, the second metal 202 can be prepared by processing a material (aluminum in this embodiment) of the second metal 202 into a predetermined shape.

In this embodiment, the second metal 202 has a plate shape. The second metal 202 includes a recessed portion 202a in which a flange portion 201b of the first metal 201 is housed on one surface 202f1. The recessed portion 202a has a shape corresponding to an outer shape of the flange portion 201b. A bottom portion 202a1 of the recessed portion 202a has a circular shape corresponding to a shape of an end portion 201a1 of the first metal 201. A side circumferential surface 202a2 of the recessed portion 202a is formed to extend perpendicular from the bottom portion 202a1 toward an opening. The second metal 202 includes a recessed portion 202b with which a horn 100 that will be described later is contacted on the other surface 202f2. The horn 100 is contacted with a bottom portion 202b1 of the recessed portion 202b. In this embodiment, the recessed portion 202b has a rectangular shape. The recessed portion 202b is provided in the second metal 202, so that a position in which the horn 100 is contacted can be positioned.

The first metal 201 and the second metal 202 described above are stacked and ultrasonically joined, thereby producing a terminal component 200. The horn 100 that transmits ultrasonic vibration to a workpiece to be joined (herein, the first metal 201 and the second metal 202) is used for ultrasonic joining. The horn 100 is mounted on an unillustrated ultrasonic oscillator. With the first metal 201 and the second metal 202 sandwiched between the horn 100 and an anvil 110, ultrasonic vibration is applied to the first metal 201 and the second metal 202 while pressurizing the first metal 201 and the second metal 202, thereby joining the first metal 201 and the second metal 202 to each other. The horn 100 used for the above-described ultrasonic joining will be described below.

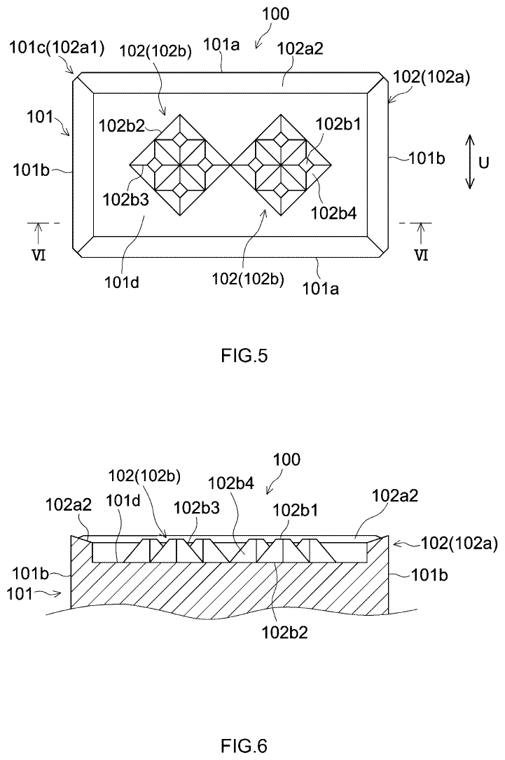

FIG. 5 is a schematic view of the horn 100 when viewed from top. In FIG. 5, a shape of a surface of the horn 100 that is contacted with the workpiece to be joined is illustrated. FIG. 6 is a cross-sectional view illustrating a cross section taken along the line VI-VI of FIG. 5. As illustrated in FIG. 5, the horn 100 includes a base portion 101 and a tip end portion 102 that protrudes from the base portion 101 and is pressed against the workpiece to be joined. The base portion 101 has a rectangular shape when viewed from top. The base portion 101 includes a pair of short-side side surfaces 101a and a pair of long-side side surfaces 101b. In the base portion 101, corner portions 101c are chamfered. There is no particular limitation on a material of the horn 100. For example, cemented carbide, high speed steel, and die steel can be used.

The tip end portion 102 is provided on an upper surface 101d of the base portion 101. At least a portion of the tip end portion 102 is a frame-like raised portion 102a formed into a frame shape. In this embodiment, the frame-like raised portion 102a rises perpendicular from the upper surface 101d of the base portion 101 along the side surfaces 101a and 101b (see FIG. 5 and FIG. 6). An outer shape of the frame-like raised portion 102a is a shape corresponding to the outer shape of the base portion 101 when viewed from top. Similar to the corner portions 101c of the base portion 101, corner portions 102a1 of the frame-like raised portion 102a are chamfered. As described above, in the frame-like raised portion 102a, the corner portions 102a1 may be processed by C-chamfering, R-processing, or the like. Thus, occurrence of burrs in portions with which the corner portions 102a1 are contacted during ultrasonic joining can be reduced.

In this embodiment, the frame-like raised portion 102a has a rectangular shape when viewed from top. An upper surface 102a2 of the frame-like raised portion 102a is an inclined surface that is inclined such that a height thereof reduces from an outer side to an inner side (see FIG. 6). As described above, the upper surface 102a2 of the frame-like raised portion 102a is an inclined surface, so that occurrence of burrs during ultrasonic joining can be reduced.

In this embodiment, the frame-like raised portion 102a has a rectangular shape but is not limited to the embodiment. The frame-like raised portion 102a may have, for example, a square shape. The frame-like raised portion 102a may have a polygonal shape, such as a hexagonal shape or the like, and may have some other shape than a polygonal shape, that is, for example a circular shape, an elliptical shape, or the like. Two or more frame-like raised portions may be provided. Note that the frame-like raised portion may be formed into substantially a frame shape and it is not necessary to form the frame-like raised portion such that the entire frame-like raised portion is continuous. That is, a case where the frame-like raised portion has a discontinuous portion in a portion thereof included a concept of the frame-like raised portion. It is preferable that most of the frame-like raised portion is continuously formed. It is preferable that 90% or more of a periphery length of the frame-like raised portion is continuously formed, it is more preferable that 95% or more thereof is continuously formed, and it is further more preferable that the frame-like raised portion is continuously formed without any break.

The tip end portion 102 may be provided with a portion that is pressed against the workpiece to be joined, in addition to the frame-like raised portion 102a. In this embodiment, as a portion of the tip end portion 102, an inner-side raised portion 102b is provided inside the frame-like raised portion 102a. That is, in this embodiment, the tip end portion 102 is formed of the frame-like raised portion 102a and the inner-side raised portion 102b. Each of the frame-like raised portion 102a and the inner-side raised portion 102b may have a height that allows a corresponding one of the portions to be pressed against the workpiece to be joined during ultrasonic joining. That is, the respective heights of the frame-like raised portion 102a and the inner-side raised portion 102b may be about the same. In this embodiment, the height of the inner-side raised portion 102b is slightly lower than a highest portion of the upper surface 102a2 of the frame-like raised portion 102a (see FIG. 6). As described above, by forming the frame-like raised portion 102a and the inner-side raised portion 102b such that the height of the frame-like raised portion 102a is higher than that of the inner-side raised portion 102b, the frame-like raised portion 102a is pressed hard against the workpiece to be joined. Thus, in a portion in which the frame-like raised portion 102a is pressed, joining strength of the workpieces to be joined can be increased.

The inner-side raised portion 102b is provided inside the frame-like raised portion 102a when viewed from top. The inner-side raised portion 102b has a quadrangular prismatic trapezoidal shape in which each of an upper surface 102b1 and a bottom surface 102b2 has a square shape. In the embodiment illustrated in FIG. 5, four inner-side raised portions 102b are provided on each of left and right portions in a long side direction of the base portion 101. Bottom surfaces 102b2 of adjacent ones of the inner-side raised portions 102b are contacted with each other. Each oblique side 102b3 of each of the inner-side raised portions 102b is provided in parallel to one of side surfaces 101a and 101b of the base portion 101. Each inclined surface 102b4 of each of the inner-side raised portions 102b is provided so as not to form a surface parallel to any one of the side surfaces 101a and 101b.

The number and shape of the inner-side raised portions 102b are not limited to the above-described embodiment. The shape or the like of the inner-side raised portion 102b is set as appropriate in accordance with joining conditions during ultrasonic joining. The inner-side raised portion 102b may have, for example, a hexagonal pyramid shape, an octagonal pyramid shape, or the like. In the above-described embodiment, as for the inner-side raised portion 102b, adjacent ones of the inner-side raised portions 102b are contacted with each other such that the bottom surfaces 102b2 thereof are contacted with each other. However, a gap or a trench may be provided between adjacent ones of the inner-side raised portions 102b. The inner-side raised portions 102b may be provided such that each inclined surface 102b4 is in parallel to either the side surfaces 101a or the side surfaces 101b of the base portion 101. The tip end portion 102 may be provided in some other portion than the frame-like raised portion 102a and the inner-side raised portions 102b. For example, a portion of the tip end portion 102 may be provided outside the frame-like raised portion 102a and may be provided both inside and outside the frame-like raised portion 102a.

Ultrasonic joining of the first metal 201 and the second metal 202 is performed using the above-described horn 100. As illustrated in FIG. 4, in this embodiment, the second metal 202 is stacked on the first metal 201 such that the flange portion 201b of the first metal 201 is accommodated in the recessed portion 202a of the second metal 202. Subsequently, the first metal 201 is set in the anvil 110 with the second metal 202 stacked thereon. The horn 100 is contacted with the bottom portion 202b1 of the recessed portion 202b of the second metal 202. In a state where the horn 100 is caused to vibrate by the ultrasonic oscillator, the horn 100 is pressurized against the second metal 202 to form a joining portion 203 provided by ultrasonic joining in a boundary surface of the first metal 201 and the second metal 202.

There is no particular limitation on a vibration direction of the horn 100 during ultrasonic joining. Herein, a vibration direction U is set to a short-side direction of the horn 100 and ultrasonic joining is performed (see FIG. 5). As described above, by setting the vibration direction U to a direction parallel to short sides of the frame-like raised portion 102a, joining strength provided by ultrasonic joining can be increased.

Note that ultrasonic vibration transmitted from the ultrasonic oscillator is set as appropriate in accordance with types of metals of the first metal 201 and the second metal 202, dimensions, a shape of the horn, or the like. The ultrasonic vibration is not limited thereto and, for example, can be set such that an amplitude is about 10 μm to 80 μm, a frequency is about 15 kHz to 150 kHz, and an energy amount given to the workpieces to be joined is about 50 J to 500 J.

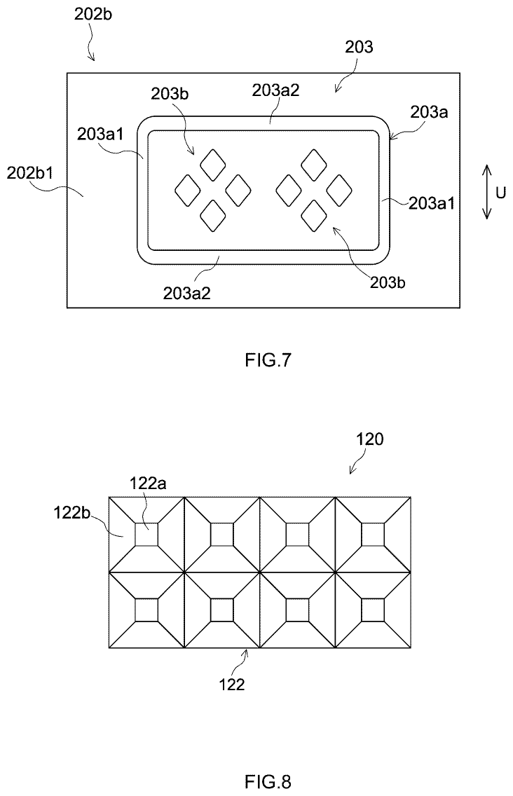

In the terminal component 200 produced using the above-described horn 100, the joining portion 203 in accordance with a shape of the tip end portion 102 (see FIG. 5) of the horn 100 is formed in the boundary surface of the first metal 201 and the second metal 202. FIG. 7 is a schematic view illustrating the shape of the joining portion 203. In FIG. 7, the joining portion 203 formed in the bottom portion 202b1 of the recessed portion 202b of the second metal 202 is illustrated, and illustration of the first metal 201 is omitted.

As illustrated in FIG. 7, the joining portion 203 includes a frame-like joining area 203a formed into substantially a frame shape. The frame-like joining area 203a has a rectangular shape. The frame-like joining area 203a has short-side portions 203a1 corresponding to short sides of the frame-like raised portion 102a (see FIG. 5) of the horn 100 and long-side portions 203a2 corresponding to long sides thereof. In this embodiment, as described above, the vibration direction U is set to a direction parallel to the short sides of the frame-like raised portion 102a and thus ultrasonic joining is performed.

In this embodiment, the joining portion 203 further includes an inner-side joining portion 203b formed inside the frame-like joining area 203a. The inner-side joining portion 203b is formed in a portion corresponding to the inner-side raised portion 102b of the horn 100, that is, a portion with which the upper surface 102b1 of the inner-side raised portion 102b of the horn 100 is contacted (see FIG. 5 and FIG. 7).

As described above, the terminal component 200 is produced using the horn 100 that is the frame-like raised portion 102a obtained by forming a portion of the tip end portion 102 into a frame shape. Thus, joining strength of the joining portion 203 is increased. The present inventor considers that a reason why the joining strength of the joining portion is increased by performing ultrasonic joining using the horn 100 including the frame-like raised portion 102a is as follows. A periphery length of an outer periphery of the joining portion contributes to joining strength more than an area of the joining portion. In ultrasonic joining, in a portion with which a horn is contacted, joining strength of a portion around a center of the joining portion tends to be high. Therefore, the horn that does not include a frame-like raised portion can be strongly joined only in a portion around a center of the joining portion. In contrast, the horn 100 including the frame-like raised portion 102a is formed such that a portion that is strongly joined is formed in accordance with the shape of the frame-like raised portion 102a, and therefore, a state where strong joining is provided over an entire periphery is achieved.

During ultrasonic joining, burrs can occur in a portion with which a tip end portion of the horn is contacted on a surface of a workpiece to be joined. As illustrated in FIG. 5, the horn 100 includes the frame-like raised portion 102a, so that occurrence of burrs can be distributed to inside and outside the frame-like raised portion 102a. Thus, a local roughness or a deformation of the surface of the workpiece to be joined can be reduced.

In the above-described embodiment, the frame-like raised portion 102a of the horn 100 has a rectangular shape. According to the above-described structure, joining strength of the first metal 201 and the second metal 202 can be further increased. Specifically, by making the vibration direction of the horn 100 parallel to a short-side direction of the frame-like raised portion 102a, a periphery length of a portion that vibrates is increased, so that the joining strength of the joining portion 203 can be further increased.

In the above-described embodiment, in the horn 100, the inner-side raised portion 102b is provided inside the frame-like raised portion 102a. According to the above-described structure, the inner-side raised portion 102b increases a friction force between the first metal 201 and the second metal 202, so that a positional displacement during ultrasonic joining can be reduced. Thus, the joining strength of the joining portion 203 can be increased.

As will be described below, as specific examples, test pieces that simulated the terminal component disclosed herein were produced and the joining strength of the joining portion was evaluated. Note that it is not intended to limit the present disclosure to the examples.

### First Example

A test piece made of copper and having a similar shape to that of the above-described first metal 201 was prepared. A test piece made of aluminum and having a similar shape to that of the above-described second metal 202 was prepared. The test piece made of aluminum was stacked on the test piece made of copper and the stacked pieces were fixed to an anvil. A horn having a frame-like raised portion was mounted on an ultrasonic oscillator. In this example, the horn having a tip end portion with a similar shape to that of the above-described horn 100 was used. The frame-like raised portion of the horn had a rectangular shape when viewed from top. The horn was contacted with a bottom of a recessed portion of the test piece made of aluminum and ultrasonic vibration was applied thereto under a condition where an amplitude was 20 μm, a frequency was 20 kHz, and an energy amount given to the workpieces to be joined was 100 J while pressurizing them with a load of 100 N, thereby producing a test piece of a first example.

The test piece of the first example was fixed to a load cell-type tensile test machine such that a tensile load was applied perpendicularly to a joining portion of the test piece joined by ultrasonic joining. The tensile load was applied perpendicularly to the joining potion of the test piece. A value of a load cell when the joining portion of the test piece was broken was read and the value was considered as joining strength.

Production of the above-described test piece and measurement of the joining strength of the joining portion were performed five times and an average value of the obtained values was considered as the joining strength of the test piece of the first example. The joining strength of the test piece of the first example was 254.2 N.

### first Comparative Example

FIG. 8 is a schematic view of a horn 120 used for producing the first example (which will be also hereinafter simply referred to as a “horn 120”). In FIG. 8, a shape of a surface that is contacted with a workpiece to be joined is illustrated. As illustrated in FIG. 8, a tip end portion of the horn 120 is formed of eight protrusions 122. Each of the protrusions 122 has a quadrangular prismatic trapezoidal shape having a square upper surface 122a and inclined surfaces each having a trapezoid shape. The protrusions 122 are arranged such that bottom surfaces of adjacent ones of the protrusions 122 are in contact with each other. An outer periphery dimension of the tip end portion of the horn 120 is the same as an outer periphery dimension of the tip end portion of the horn used for producing the first example (that is, an outer periphery dimension of the frame-like raised portion).

Except that the horn 120 was used, similar to the first example, a test piece of the first comparative example was produced and joining strength was measured. Production of the test piece of the first comparative example and measurement of joining strength of a joining portion were performed five times. An average value of the obtained joining strengths was considered as the joining strength of the test piece of the first comparative example. The joining strength of the test piece of the first comparative example was 146.5 N. Based on results described above, it was found that, even with the same outer periphery dimension of a surface that is contacted with a workpiece to be joined, joining strength can be increased by using a horn including a frame-like raised portion.

A terminal component, a horn used when producing the terminal component, and a secondary battery disclosed herein have been described above in various manners. The embodiment of the horn, the terminal component, and the secondary battery disclosed herein shall not limit the present disclosure, unless specifically stated otherwise. Various changes can be made to contents disclosed herein and each of components and processes described herein can be omitted as appropriate or can be combined with another one or other ones of the components and the processes as appropriate, unless a particular problem occurs.

What is claimed is:

1. A horn that transmits ultrasonic vibration to a workpiece to be joined, the horn comprising:
a base portion; and
a tip end portion that protrudes from the base portion and is pressed against the workpiece,
wherein at least a portion of the tip end portion is a frame-like raised portion formed into a frame shape,
90% or more of a periphery length of an upper surface of the frame-like raised portion is continuously formed in a circumferential direction, and
the upper surface of the frame-like raised portion is an inclined surface that is inclined such that a height thereof reduces from an outer side to an inner side.

2. The horn according to claim 1,
wherein the frame-like raised portion is formed into a rectangular shape.

3. The horn according to claim 1,
wherein, as a portion of the tip end portion, an inner raised portion is provided inside the frame-like raised portion.
